(19) United States
(12) Patent Application Publication
(10) Pub. No.: US 2003/0186107 A1
(43) Pub. Date: Oct. 2, 2003

(54) High performance fuel cells

(76) Inventors: Valerie A. Maston, Pittsfield, MA (US); Paul Farris, South Windsor, CT (US); Joseph F. Egan, Enfield, CT (US)

Correspondence Address: Mary R. Bonzagni, Esq., HOLLAND & BONZAGNI, P.C., Suite 302, 171 Dwight Road, Longmeadow, MA, 01106-1700, US

(21) Appl. No.: 10/376,144

(22) Filed: Feb. 28, 2003

Related U.S. Application Data
(60) Provisional application No. 60/361,680, filed on Mar. 4, 2002.

(51) Int. Cl. H01M 4/86; H01M 4/96; H01M 8/08

(52) U.S. Cl. 429/38; 429/40; 429/42; 429/44; 429/46

(57) ABSTRACT

Electrode plates having a plurality of open-faced channels formed in at least one surface thereof are provided. The inventive electrode plates, which are contemplated for use in a variety of fuel cell types, preferably serve to increase the degree and rate of heat transfer within a fuel cell, thereby extending the cell's practical operating range and useful life. High performance fuel cells and fuel cell stacks constructed of these inventive electrode plates are also provided, as well as, acid fuel cells employing (i) an absorptive separator that absorbs and retains an acid or mixed acid electrolyte, or (ii) a non-absorptive separator that retains an acid or mixed acid gel electrolyte.

### RELATED APPLICATION

This application claims priority from U.S. Provisional Patent Application No. 60/361,680, filed Mar. 4, 2002.

### FIELD OF THE INVENTION

The present invention relates to fuel cells, and more particularly relates to high performance fuel cells constructed of electrode plates having a plurality of open-faced channels formed in at least one surface thereof. In a preferred embodiment, the channels serve to increase the degree and rate of beat transfer within the fuel cell, thereby extending the practical operating range and the useful life of the cell. The present invention further relates to acid fuel cells that employ (i) an absorptive separator and an electrolyte, where the separator absorbs and retains the electrolyte, or (ii) a non-absorptive separator and a gelled electrolyte, where the separator retains the gelled electrolyte.

### BACKGROUND

Electrochemical fuel cells serve to convert fuel and oxidant to electricity and reaction product.

A particularly important class of fuel cells with promise for stationary and mobile electricity generation is the low temperature H₂/O₂ fuel cells. These solid polymer electrochemical fuel cells generally employ an ion exchange membrane or solid polymer electrolyte located between two electrodes or porous, electrically conductive plates (i.e., a membrane/electrode assembly or MEA). The electrodes, which are typically modified with a noble metal catalyst to induce the desired electrochemical reaction, are electrically coupled to provide a circuit for conducting electrons between the electrodes through an external circuit.

In operation, fuel (i.e., hydrogen) is supplied to the anode and oxidant (i.e., air/oxygen) is supplied to the cathode. The fuel and the oxidant are decomposed electrolytically at the electrodes via redox or separate half-reactions, which are summarized below:

Anode Reaction

H₂→2H⁺+2e⁻

Cathode Reaction

½O₂+2H⁺+2e^{-→}2H₂O

The protons produced at the anode migrate through the ion exchange membrane or solid polymer electrolyte to the cathode, while the electrons travel from the anode to the cathode via the external circuit. At the cathode, oxygen combines with the protons and electrons to form water as the reaction product.

The MEA is typically disposed between electrically conductive fluid flow plates or collector plates. Fluid flow plates, which contain a plurality of flow passages, direct fuel or oxidant to the respective electrodes and reaction product out of the cell(s). Fluid flow plates also act as current collectors and provide support for the electrodes. Collector plates, which do not contain flow passages, are used in conjunction with plates having such flow passages.

Prior art low temperature H₂/O₂ fuel cells have been observed to experience a drop-off in power with age due in part to inadequate cooling and poor internal distribution of reactant gases, which leads to thermal hot spots which in turn leads to cell failure and the like.

Attempts to improve the performance of such prior art H₂/O₂ fuel cells have primarily been directed toward improving the high temperature performance of the ion exchange membranes, increasing the degree of membrane humidification and increasing reactant and coolant distribution within the cells through the use of complex fluid flow passages.

For example, U.S. Pat. No. 6,303,245 to Nelson discloses a fluid flow element or plate which has a front surface in which is formed a first plurality of open-faced, fuel flow channels and a second plurality of open-faced, hydration channels. The fluid flow element or plate is used in conjunction with a multi-component electrode assembly and reportedly serves to increase the evenness of hydration water distribution within the active area of the cell, provides more uniform cooling of the fluid flow field, decreases the fuel assembly cooling load and provides higher stack performance. See Col. 3, lines 42 to 55, of U.S. Pat. No. 6,303,245.

The complexity of the channel design in the fluid flow element or plate disclosed in U.S. Pat. No. 6,303,245 will increase the cost of manufacture of the host cell and will require more complex stack controls. In addition, while this cell design will work under steady state (fixed load) conditions, it is not well suited for variable load conditions typically found in back-up power, uninterruptible power supply (UPS), automotive and off-grid applications.

A need exists for a high power density fuel cell that overcomes the drawbacks associated with prior art fuel cells.

It is therefore an object of the present invention to provide such a fuel cell.

It is a more particular object of the present invention to provide a more efficient, high power density fuel cell having an extended practical operating range and useful life that is not limited in terms of platform size or area.

It is another more particular object of the present invention to provide an electrode plate for use in a fuel cell that serves to direct and distribute coolant fluids thereby increasing the degree and rate of heat transfer within the cell.

It is another more particular object to provide an electrode plate that serves to direct and distribute reactant fluids within the cell.

It is yet another more particular object of the present invention to provide high performance cathode and anode electrode plates for use in fuel cells.

### SUMMARY

The present invention therefore provides an electrode plate having opposing surfaces, wherein at least one surface has a plurality of open-faced channels formed therein, with each channel having an inlet end and an outlet end.

The present invention further provides a fuel cell comprising:

(a) an anode electrode plate;

(b) a cathode electrode plate; and

(c) an electrolyte located between the anode and cathode electrode plates,

wherein, each electrode plate has opposing first and second surfaces, the first surface of each plate being adjacent to the electrolyte and the first and/or second surface of each plate having a plurality of open-faced channels formed therein, with each channel having an inlet end and an outlet end.

The present invention also provides a fuel cell stack comprising, in cooperative combination, a plurality of the fuel cells described above.

Also provided by way of the present invention is an acid fuel cell that comprises:

(a) an anode electrode plate;

(b) a cathode electrode plate; and

(c) an electrolyte located between the anode and cathode electrode plates,

wherein, the electrolyte is selected from the group of (i) an absorptive separator and an electrolyte comprising one or more acids, wherein the absorptive separator absorbs and retains the electrolyte, and (ii) a non-absorptive separator and a gelled electrolyte comprising one or more acid gels, wherein the non-absorptive separator retains the gelled electrolyte.

The foregoing and other features and advantages of the present invention will become more apparent from the following description and accompanying drawings.

### BRIEF DESCRIPTION OF THE DRAWINGS

Particular features of the disclosed invention are illustrated by reference to the accompanying drawings in which:

FIG. 1 is a side plan view of a preferred embodiment of the electrode plate of the present invention having a plurality of open-faced channels formed in a surface thereof;

FIG. 2 is a side plan view of another preferred embodiment of the inventive electrode plate where one surface has a recessed portion with a fibrous composite material formed therein and where an opposing surface has a plurality of open-faced channels formed therein;

FIG. 3 is an off-axis bottom view of the electrode plate of FIG. 2;

FIG. 4 is a side plan view of a preferred embodiment of the electrode plate of the present invention where (i) one surface has a plurality of open-faced channels formed therein, (ii) an opposing surface has a recessed portion with a plurality of open-faced channels and a fibrous composite material formed therein and (iii) the flow fields formed by the open-faced channels of one surface are substantially parallel to the flow fields formed by the open-faced channels of the opposing surface;

FIG. 5 is an off-axis top view of a more preferred embodiment of the anode electrode plate of the present invention where (i) one surface has a plurality of open-faced channels formed therein, (ii) an opposing surface has a recessed portion with a plurality of open-faced channels and a fibrous composite material formed therein, and (iii) the flow fields formed by the open-faced channels of one surface are substantially perpendicular to the flow fields formed by the open-faced channels of the opposing surface;

FIG. 6 is an off-axis top view of a preferred embodiment of the fuel cell of the present invention where (i) each electrode plate has a plurality of open-faced channels in only one surface thereof, and (ii) the flow fields formed by the open-faced channels of one electrode plate are substantially parallel to the flow fields formed by the open-faced channels of the other electrode plate;

FIG. 7 is an off-axis top view of a more preferred embodiment of the fuel cell of the present invention employing a double-sided channeled anode and cathode electrode plate, with each electrode plate having one surface with a plurality of open-faced channels formed therein and an opposing surface with a recessed portion having a plurality of open-faced channels and a fibrous composite material formed therein, where (i) the flow fields formed by the outer open-faced channels of one electrode plate are substantially parallel to the flow fields formed by the outer open-faced channels of the other electrode plate, and (ii) the flow fields formed by the inner open-faced channels of one electrode plate are substantially perpendicular to the flow fields formed by the inner open-faced channels of the other electrode plate;

FIG. 8 is a perspective side view of a preferred embodiment of the electrochemical fuel cell stack of the present invention which employs a plurality of the FIG. 6 fuel cells; and

FIG. 9 is a perspective side view of a more preferred embodiment of the inventive stack employing a plurality of the FIG. 7 fuel cells, and a partial cutaway view of an external manifold system used in cooperation therewith.

### DETAILED DESCRIPTION OF THE PREFERRED EMBODIMENT

The electrode plates of the present invention are configured or designed to serve as either an anode or a cathode electrode plate and therefore serve to effect and support an electrolytic reaction within an electrochemical fuel cell.

The inventive electrode plates are contemplated for use in a variety of fuel cell types including, but not limited to, sulfuric acid fuel cells (SAFC), proton exchange membrane fuel cells (PEM-type fuel cells), direct alcohol fuel cells (DAFC), phosphoric acid fuel cells (PAFC), alkaline fuel cells (AFC) and metal/air fuel cells.

As will be described in more detail below, the electrode plates of the present invention have opposing surfaces, where at least one surface has a plurality of open-faced channels formed therein, with each channel having an inlet end and an outlet end.

In one embodiment, the channels are coolant channels that serve to increase the heat transfer capabilities of the host fuel cell, thereby extending the practical operating range and the useful life of the cell. The superior heat transfer capabilities provided by way of this embodiment allow for increases in the platform size or area of the host fuel cells, rendering such cells suitable for use not only in transportation applications, which require light and very small power sources, but also in residential, commercial and industrial applications, which may require heavier and larger power sources.

In another embodiment, the channels are reactant channels that are formed in the surface of the electrode plate adjacent to the cell's active area. The reactant channels serve to distribute reactant fluids over the entire active area, thereby increasing the activity of the catalyst and the useful output of the fuel cell.

In yet another embodiment, coolant channels are formed in one surface of the inventive electrode plate while reactant channels are formed in an opposing surface.

As illustrated in FIGS. 1 to 5, the electrode plate of the present invention, which is shown generally at 10, has opposing first and second surfaces 12, 14. The first surface 12 is preferably coated with a catalyst (e.g., platinum or platinum/ruthenium) and may adopt or employ a number of different surface configurations. For example, the first surface 12 of electrode plate 10 may adopt a planar configuration or, as described in more detail below, a channeled configuration, a recessed configuration, or a recessed channeled configuration.

The second surface 14 of electrode plate 10 may adopt a planar configuration, or may have a plurality of open-faced channels 16 formed therein, which serve as coolant flow fields to increase heat transfer. Each such channel 16 has an inlet end and an outlet end and may adopt any cross-sectional profile. In a preferred embodiment, each channel 16 has a height ranging from about 100 to about 10,000 microns, a width ranging from about 50 to about 3500 microns, and is spaced from about 50 to about 3500 microns from adjacent channels. The channels 16 may be engraved or milled into the second surface 14. In the alternative, channeled electrode plate 10 may be injection or compression molded.

In one embodiment of the inventive electrode plate 10, and as best shown in FIG. 1, the first surface 12 adopts a planar configuration, while the second surface 14 adopts a channeled configuration.

In another embodiment (not shown), the first surface 12 of electrode plate 10 also adopts a channeled configuration. More specifically, a plurality of open-faced channels are also formed in surface 12. The open-faced channels formed in surface 12 serve as reactant flow fields, with each channel having an inlet end and an outlet end and adopting any cross-sectional profile. In a preferred embodiment, the height, width and spacing of each channel formed in surface 12 are similar to that noted above for channel 16.

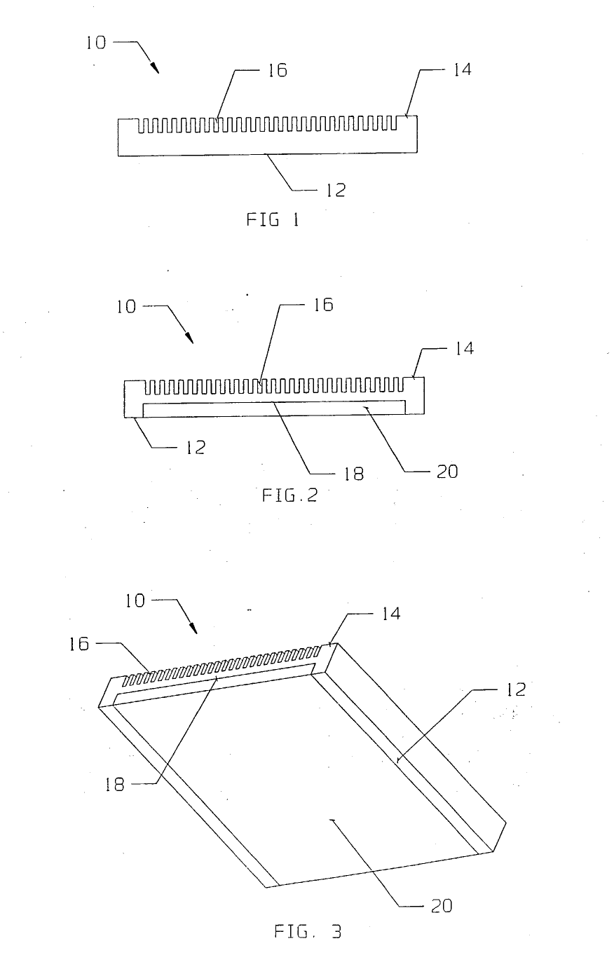

In a preferred embodiment, and as best shown in FIGS. 2 and 3, the first surface 12 of electrode plate 10 contains a recessed portion 18 having a fibrous composite material 20 formed therein. In a more preferred embodiment, the fibrous composite material 20 is a carbon fiber composite material, which serves to increase the electrical conductivity of electrode plate 10. Such a material may be prepared by compressing carbon powder into a coherent mass and subjecting the mass to high temperature processes for the purpose of binding the carbon particles together and converting a portion of the bound mass to graphite. The mass may then be cut into slices and the slices formed into the recessed portion 18 of first surface 12.

In yet a more preferred embodiment, the carbon fiber composite material 20 is a rigid, open, monolithic structure with high permeability. The composite material 20, which preferably has a thickness ranging from about 1.5 to about 10 millimeters (mm), allows fluids to easily flow through the material, and when activated, the carbon fibers provide a porous structure for adsorption. Such materials are described in U.S. Pat. Nos. 5,827,355 and 6,030,698, which are incorporated in their entireties herein by reference.

In another more preferred embodiment, fibrous composite material 20 is a polytetrafluoroethylene (PTFE) (e.g., TEFLON) fiber composite material.

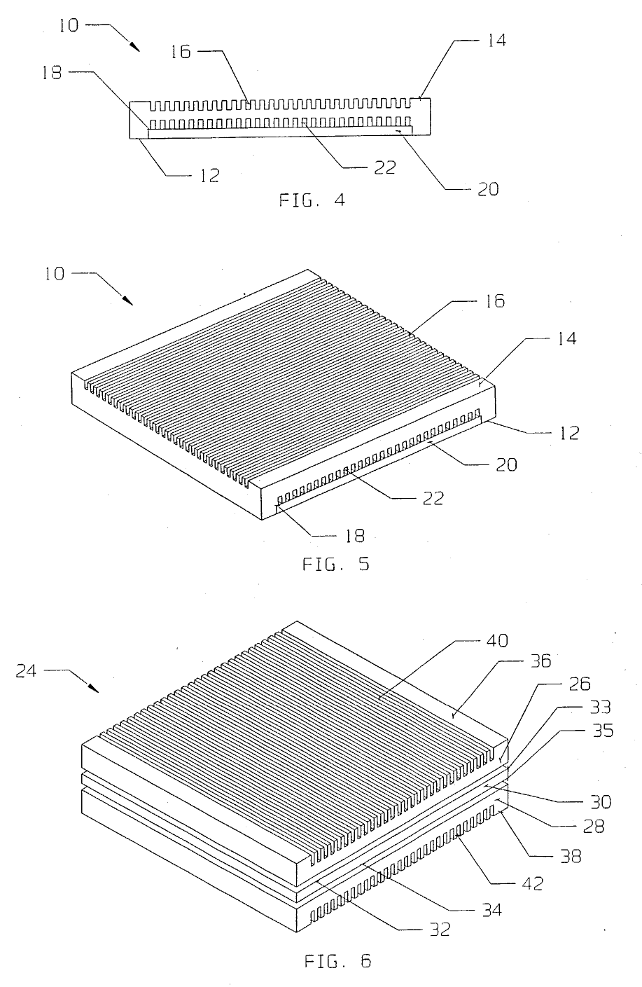

In yet another more preferred embodiment, and as best shown in FIG. 4, recessed portion 18 of first surface 12 also contains a plurality of open-faced channels 22 formed therein, which serve as flow fields to distribute fuel or oxidant over the active area of electrode plate 10. Each channel 22 has an inlet end and an outlet end and may adopt any cross-sectional profile. Preferably, each channel 22 has a height ranging from about 100 to about 10,000 microns (more preferably, from about 100 to about 1500 microns), a width ranging from about 50 to about 3500 microns (more preferably, from about 50 to about 750 microns), and is spaced from about 50 to about 3500 microns (more preferably, from about 50 to about 750 microns) from adjacent channels.

While the heat transfer flow fields formed by channels 16 may adopt any orientation relative to the reactant flow fields formed by e.g. channels 22, it is preferred that they adopt a substantially parallel orientation in the cathode electrode plate and, as best shown in FIG. 5, a substantially perpendicular orientation in the anode electrode plate. As will be readily appreciated, these flow field orientations lead to a cross flow arrangement on the anode and a parallel flow arrangement on the cathode, which allows an air manifold to simultaneously provide both reactant air and cooling air to the fuel cell or stack.

As is well known to those skilled in the art, reactant and coolant fluid streams may be supplied to a fuel cell or stack, and depleted reactant and coolant streams and reaction products removed therefrom, via external and/or internal manifold systems.

When external manifold systems are employed, the manifold is preferably disposed on a peripheral edge portion (not shown) of electrode plate 10. More specifically, the peripheral edge portion is located on the edge of electrode plate 10 perpendicular to the flow fields and is preferably at least twice as wide as the thickness of the manifold being disposed thereon, so as to provide an adequate seal area.

When internal manifold systems are employed, electrode plate 10 is further provided with a frame portion containing through apertures, with each such aperture forming a part of either a fuel, oxidant or coolant stream inlet port/manifold, or a depleted reactant, coolant, or reaction product stream manifold/outlet port.

The electrode plate 10 of the present invention is porous (i.e., having a degree of porosity ranging from about 60 to about 90%), allowing reactant fluids (e.g., gas molecules) to diffuse or pass through electrode plate 10 to the catalyst layer, yet must satisfy certain minimum strength requirements to enable it to resist deformation during cell assembly and operation.

In a preferred embodiment, electrode plate 10 is a porous carbonaceous plate structure that demonstrates good heat and corrosion resistance, electrical conductivity and mechanical strength. Such structures may be prepared using conventional fabrication methods and techniques. For example, electrode plate 10 may be prepared by: (1) mixing a carbonaceous material (e.g., from about 50 to about 70% by weight, based on the total weight of the mixture, of a carbonaceous material selected from the group including graphite, carbon black, carbon fibers, and mixtures thereof) and a binder (e.g., from about 50 to about 30% by weight, based on the total weight of the mixture, of a PTFE binder); (2) pouring the resulting mixture into a mold; and (3) applying heat and pressure to the mixture contained in the mold to form an integral but porous structure.

The resulting plate structures are then either: (1) catalyst (e.g., platinum or platinum/ruthenium) plated in the active areas or central portions; or (2) fitted with fibrous composite material 20.

Plate structures fitted with fibrous composite material 20 are then coated with a catalyst (e.g., platinum or platinum/ruthenium) and, in a preferred embodiment, are further coated with a polymer material (e.g., PTFE) to aid in reducing cell internal resistance.

For sulfuric acid fuel cells, the plate structures are preferably fitted with a TEFLON fiber composite material 20 and the structures dipped in sulfuric acid after the catalyst coating is applied to composite material 20 so as to aid in further reducing cell internal resistance.

As will be readily appreciated, the overall size or dimensions of electrode plate 10 will depend upon the size of the host fuel cell and the operating conditions thereof.

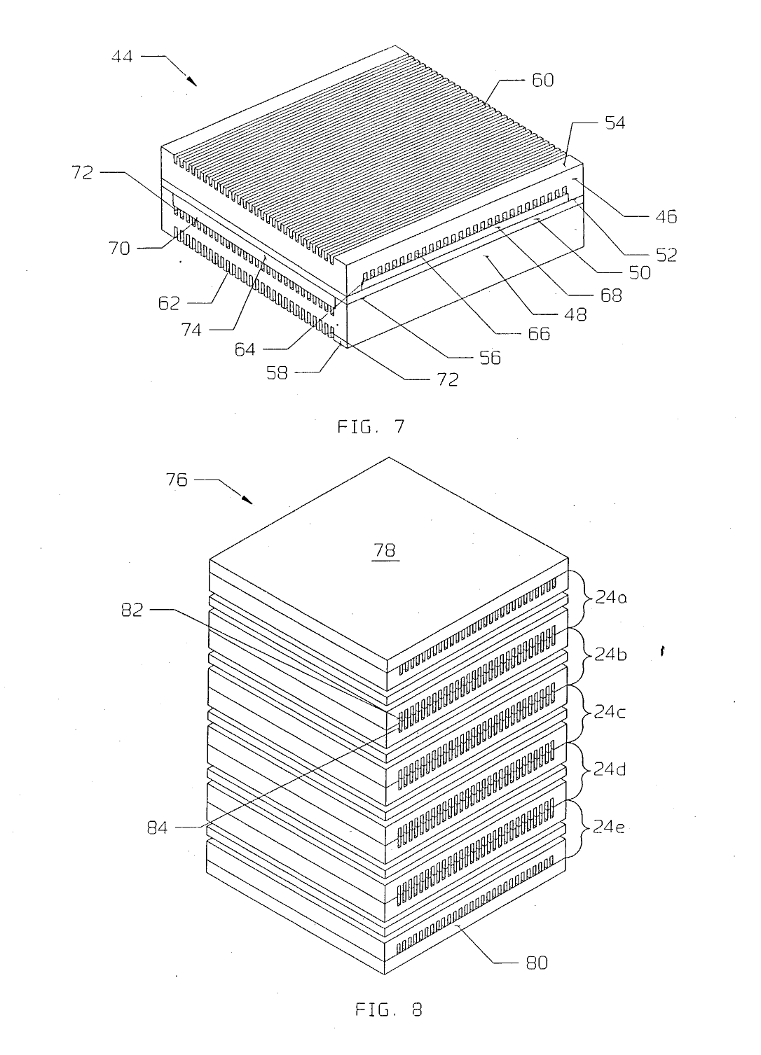

Referring now to FIG. 6 in detail, reference numeral 24 has been used to generally designate a preferred embodiment of the fuel cell of the present invention. As noted above, fuel cell 24 basically comprises an anode electrode plate 26, a cathode electrode plate 28 and an electrolyte 30. In this preferred embodiment, electrode plates 26, 28 are spaced slightly apart from electrolyte 30, which has catalyst layers 33, 35 formed on opposing sides thereof, and the second surface 36, 38 of each electrode plate 26, 28 has a plurality of open-faced channels 40, 42 formed therein.

The type of electrolyte 30 is typically determined by the type of fuel cell. For example, for direct alcohol and PEM-type fuel cells, electrolyte 30 comprises an ion exchange membrane or solid polymer electrolyte that serves to convert the chemical energy of hydrogen and oxygen directly into electrical energy. The solid polymer electrolyte permits the passage of protons from the anode side of the fuel cell to the cathode side of the fuel cell while preventing passage of reactant fluids such as hydrogen and oxygen gases.

Such membranes are available from E. I. DuPont de Nemours and Company, 1007 Market Street, Wilmington, Del. 19898, under the product designation NAFION ion exchange membrane, and from W. L. Gore & Associates, Inc., 555 Paper Mill Road, Newark, Del. 19711, under the product designation GORE-SELECT membrane.

For alkaline, phosphoric acid and sulfuric acid fuel cells, which do not use a polymer membrane as an electrolyte, electrolyte 30 comprises a porous matrix filled with a liquid electrolyte. The electrolyte matrix permits the passage of protons from the anode side of the fuel cell to the cathode side of the fuel cell while preventing the mixing of fuel gas disposed on one side of the matrix with oxidant disposed on an opposing side. The matrix must, therefore, be highly gas impermeable and highly ionically conductive. It must also be corrosion resistant to the electrolyte. An example of such a matrix is a porous, carbonaceous matrix that is prepared in accordance with conventional fabrication methods and techniques such as that described above for electrode plate 10.

In a preferred embodiment, fuel cell 24 is an acid fuel cell and electrolyte 30 comprises an absorptive or sponge-like separator and an acid or mixed acid electrolyte that is absorbed and retained by the separator. The acid or mixed acid electrolyte may take the form of a liquid and/or a gelled electrolyte. More preferably, electrolyte 30 is a multi-layer structure that comprises the following layers in the order specified: a first gas diffusion layer, a first catalyst (e.g., platinum or platinum/ruthenium) layer, an absorptive separator, a second catalyst layer and a second gas diffusion layer.

Suitable absorptive separators are those separators that serve to immobilize virtually all of the liquid acid or mixed acid electrolyte present in fuel cell 24, permitting the passage of protons through the immobilized electrolyte, while preventing the mixing of fuel gas disposed on one side of electrolyte 30 with oxidant disposed on an opposing side. Preferably, the absorptive separator is a non-woven sheet formed from fibers such as fine glass fibers and/or inorganic (e.g., polypropylene) fibers that have been rendered hydrophilic. Fine glass fiber separators are available from Hollingsworth & Vose Company Inc., 112 Washington Street, East Walpole, Mass. 02032-1008 (“Hollingsworth & Vose”), under the trade designation HOVOSORB® II microglass separators. Non-woven separators prepared from inorganic fibers (e.g., polypropylene and/or polyethylene fibers) that have been graft-polymerized with a vinyl monomer (e.g., an acrylic acid monomer) so as to render the separator hydrophilic, are described in U.S. Pat. No. 5,922,417 to Singleton et al. and U.S. Pat. No. 6,384,100 to Choi, and are available from Hollingsworth & Vose, under the trade designation HOVOSORB® battery separators.

In one other such preferred embodiment, the absorptive separator is replaced with a non-absorptive separator and the acid or mixed acid electrolyte is replaced with an acid or mixed acid gel electrolyte that fills the acid fuel cell 24. In this embodiment, the gelled electrolyte is preferably pressed into (or through) the separator.

Suitable non-absorptive separators serve to permit the passage of protons through the gelled electrolyte contained therein, while preventing the mixing of fuel gas disposed on one side of electrolyte 30 with oxidant disposed on an opposing side. Preferably, the non-absorptive separator is a leaf type separator selected from the group of glass fiber separators, polyvinyl chloride (PVC) separators, cellulosic separators and synthetic pulp separators. More preferably, the non-absorptive separator is a porous separator that demonstrates low acid displacement, low electrical resistance, inertness, oxidation stability, mechanical stability and favorable dimensions (e.g., separators with high ribs on both sides). Examples of these more preferred separators include (1) a polyester mat embedded in a phenol-formaldehyde-resorcinol resin, which is available from Daramic, Inc., 13800 South Lakes Drive, Charlotte, N.C. 28273 (“Daramic, Inc.”), under the trade designation DARAK battery separators, (2) a PVC leaf type separator, available from Daramic, Inc., under the trade designation S-PVC polyvinyl chloride separators, and (3) cellulosic leaf type separators, also available from Daramic, Inc., under the trade designations ARMORIB-L and ARMORIB-LS cellulosic separators. The separators described above may be used in conjunction with an attached support such as a glass mat for increasing the structural integrity of the separator.

Suitable gas diffusion layers are conductive, inert and allow for reacting gas to diffuse through the layer. Examples of materials suitable for use in these layers include porous carbon fiber paper and cloth, and carbon fiber composite materials. Preferably, the gas diffusion layer is prepared using a porous carbon fiber paper available from Toray Kabushiki Kaisha (Toray Industries, Inc.) Corporation Japan, No. 2-1,2-chome, Nihonbashi-Muromachi Chuo-ku, Tokyo JAPAN, under the trade designation TORAY carbon fiber sheets.

In a more preferred embodiment, fuel cell 24 is a sulfuric acid fuel cell and electrolyte 30 comprises a fine glass fiber (or absorptive glass mat) separator and a sulfuric acid liquid electrolyte containing from about 15 to about 35% by wt. sulfuric acid. In this more preferred embodiment, the absorptive glass mat separator absorbs and retains the sulfuric acid liquid electrolyte.

In another more preferred embodiment, fuel cell 24 is a sulfuric acid fuel cell and electrolyte 30 comprises a phenol formaldehyde resin separator and either a sulfuric acid gel electrolyte or a sulfuric acid/phosphoric acid mixed acid gel electrolyte. In this more preferred embodiment, the gelled electrolyte is pressed into (or through) the separator.

The sulfuric acid fuel cells of the present invention preferably operate on hydrogen/air.

In another preferred embodiment, fuel cell 24 is a PEM-type fuel cell, which comprises: (a) an anode electrode plate; (b) a cathode electrode plate; and (c) an ion exchange membrane located between the anode and the cathode electrode plates.

For direct alcohol fuel cells, use of fibrous composite materials or monoliths in the anode electrode plate allow for other catalysts to be added to the monolith, resulting in an increase in the amount of hydrogen released to the anode.

For alkaline and metal/air fuel cells, fibrous monoliths may be coated with potassium hydroxide (KOH) for the purpose of removing carbon dioxide (CO₂) from the supplied air.

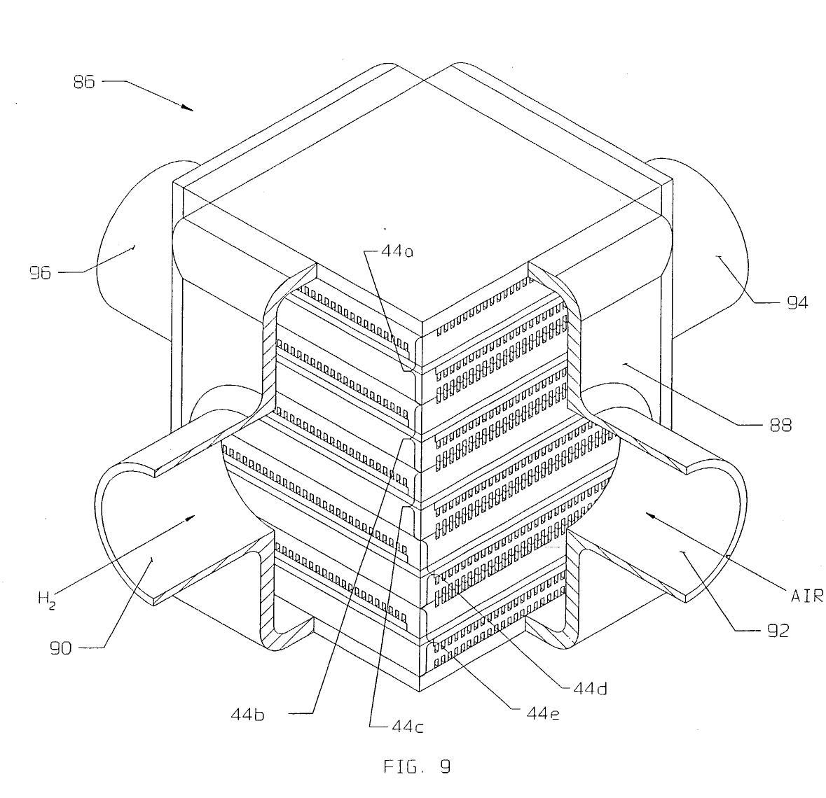

Referring now to FIG. 7 in detail, reference numeral 44 has been used to generally designate a more preferred embodiment of the fuel cell of the present invention. Fuel cell 44 basically comprises:

(a) an anode electrode plate 46;

(b) a cathode electrode plate 48; and

(c) an electrolyte 50 located between electrode plates 46, 48.

Anode and cathode electrode plates 46, 48 have opposing first and second surfaces 52, 54 and 56, 58, wherein the first surfaces 52, 56 of the plates 46, 48 (i) are each adjacent to the electrolyte 50, (ii) contain a recessed portion 64, 70 that has a plurality of open-faced channels 66, 72 formed therein, with each such channel having an inlet end and an outlet end, and (iii) have a fibrous composite material 68, 74 formed within recessed portion 64, 70, respectively. In this more preferred embodiment, the reactant flow fields formed by the open-faced channels 66 are substantially perpendicular to the reactant flow fields formed by the open-faced channels 72.

The second surfaces 54, 58 of the electrode plates 46, 48 have a plurality of open-faced channels 60, 62 formed therein, with each channel also having an inlet end and an outlet end. In this more preferred embodiment, the coolant flow fields formed by open-faced channels 60 are substantially parallel to the coolant flow fields formed by open-faced channels 62.

The fuel cells 24, 44 of the present invention are layer-built fuel cells that are required to be sealed so as to prevent leakage of fuel gas (hydrogen, oxygen, or the like) and liquid (liquid electrolyte, or water produced in the electrochemical reaction) from the fuel cell during operation. In order to prevent gas or liquid from leaking, various sealing means such as gaskets (e.g., rubber or plastic elastomer type gaskets such as VITON rubber type gaskets and GORE-TEX PTFE type gaskets), rubber plates with cellular rubber layers thereon and sealing materials such as PTFE resin are used. These gaskets, plates and/or resinous materials are placed between each fuel cell component and the cell components compressed using e.g. tie rods and end plates, to affect the seal.

In a preferred embodiment, each component of fuel cell 24, 44 are bonded together using an epoxy adhesive. In a more preferred embodiment, a removable epoxy adhesive having a relatively low debonding temperature is used, thereby facilitating fuel cell stack dismantlement, repair and upgrading. In a most preferred embodiment, the removable epoxy adhesive, which may be prepared in any size and thickness, is sized or cut to match the surfaces being attached, applied to one surface and melted. The bond is made by bringing the melted adhesive into contact with the other surface and curing between room temperature and 60° C. The adhesive can then be removed at 90 to 130° C.

Electrode plates 10, 26, 28, 46, 48, in addition to directing and distributing coolant fluid (e.g., water, air) and/or reactants and reactant products across the plates, serve as current collectors and provide support for adjacent fuel cell components.

For single-sided channel or microchannel electrode plates, the microchannels may be used for either cooling the fuel: cell or stack or for directing/distributing reactants and reaction products. When the microchannels are used only for directing/distributing reactants and reaction products, or if additional stack cooling is desired, separate cooling plates may be added to fuel cell 24, 44, or to one or more fuel cells in the stack, to remove heat. Any such cooling plate must be electrically conductive and compatible with the cell-operating environment.

When single-sided “reactant” microchannel electrode plates are used in conjunction with double-sided microchannel electrode plates, an adequate level of cooling is achieved by way of the double-sided microchannel plates, thereby obviating the need for separate cooling plates. Such a configuration allows for a smaller stack rendering the fuel cell or stack suitable for use in transportation applications, which require light and very small power sources.

For double-sided microchannel electrode plates, where the microchannels are used as flow fields for cooling the fuel cell or stack and for supplying fuel or oxidant to the electrode, the added cooling capacity allows for increased power output rendering the fuel cell or stack suitable for use in residential, commercial and industrial applications which require increased capacity while allowing for increases in weight and size.

In FIG. 8, reference numeral 76 has been used to generally designate a preferred embodiment of the fuel cell stack of the present invention. In such a stack, fuel cells 24a-e, which are connected in series, are positioned between end plates 78, 80 and are held together by e.g. tie rods and end plates (not shown) or by adhesive. In this preferred embodiment, the coolant flow fields formed by the open-faced channels in adjacent electrode plates (e.g., channels 82, 84) line up, thereby providing flow fields doubled in volume and cooling capacity.

As will be readily appreciated by those skilled in the art, for fuel cell stack designs where anode electrode plates and cathode electrode plates would lie adjacent to each other, fuel cell stack 76 further comprises impervious, but electrically conductive separator plates (not shown). These separator plates would be inserted between adjacent anode and cathode electrode plates to prevent mixing of fuel gas and oxidant.

In FIG. 9, reference numeral 86 has been used to generally designate a more preferred embodiment of the fuel cell stack of the present invention. In this more preferred embodiment, fuel cell stack 86 is air-cooled and employs a plurality of fuel cells 44a-e. An external manifold system 88 serves to introduce hydrogen and air through ports 90 and 92, respectively, while depleted reactant and coolant streams and reaction products exit through ports 94 and 96.

When the stack (or sets of fuel cells within the stack) is connected to fuel, oxidant and coolant streams via internal manifold systems, the stack typically includes: (1) inlet ports and manifolds for supplying and directing the fuel and oxidant streams to the individual fuel cell reactant flow passages; (2) inlet ports and manifolds for supplying and directing coolant streams (e.g., air, water) to the individual fuel cell coolant flow passages; (3) exhaust manifolds and outlet ports for expelling depleted reactant streams and reaction products; and (4) exhaust manifolds and outlet ports for depleted coolant streams exiting the stack.

Although this invention has been shown and described with respect to detailed embodiments thereof, it would be understood by those skilled in the art that various changes in the form and detail thereof may be made without departing from the spirit and scope of the claimed invention.

Having thus described the invention, what is claimed is:

1. An electrode plate having opposing first and second surfaces, wherein at least one surface of the electrode plate has a plurality of open-faced channels formed therein, with each channel having an inlet end and an outlet end.

2. The electrode plate of claim 1, wherein the second surface has a plurality of open-faced channels formed therein.

3. The electrode plate of claim 2, wherein the first surface is a planar surface.

4. The electrode plate of claim 3, wherein the planar first surface is coated with a catalyst.

5. The electrode plate of claim 2, wherein the first surface has a plurality of open-faced channels formed therein.

6. The electrode plate of claim 5, wherein the channeled first surface is coated with a catalyst.

7. The electrode plate of claim 5, wherein flow fields formed by the open-faced channels of the first surface are substantially parallel to flow fields formed by the open-faced channels of the second surface.

8. The electrode plate of claim 5, wherein flow fields formed by the open-faced channels of the first surface are substantially perpendicular to flow fields formed by the open-faced channels of the second surface.

9. The electrode plate of claim 2, wherein the first surface has a recessed portion that has a fibrous composite material formed therein.

10. The electrode plate of claim 9, wherein the fibrous composite material is a carbon fiber composite material.

11. The electrode plate of claim 10, wherein the carbon fiber composite material is a rigid, open, monolithic structure with high permeability.

12. The electrode plate of claim 9, wherein the fibrous composite material is a polytetrafluoroethylene fiber composite material.

13. The electrode plate of claim 9, wherein the recessed portion of the first surface has a plurality of open-faced channels formed therein.

14. The electrode plate of claim 13, wherein flow fields formed by the open-faced channels of the recessed portion of the first surface are substantially parallel to flow fields formed by the open-faced channels of the second surface.

15. The electrode plate of claim 13, wherein flow fields formed by the open-faced channels of the recessed portion of the first surface are substantially perpendicular to flow fields formed by the open-faced channels of the second surface.

16. The electrode plate of claim 1, wherein the electrode plate has a degree of porosity ranging from about 60 to about 90%.

17. The electrode plate of claim 16, wherein the electrode plate is a porous carbonaceous plate.

18. A cathode electrode plate having opposing first and second surfaces, wherein the first surface has a recessed portion that has a plurality of open-faced channels and a fibrous composite material formed therein, wherein the second surface has a plurality of open-faced channels formed therein, wherein flow fields formed by the open-faced channels of the recessed portion of the first surface of the cathode electrode plate are substantially parallel to flow fields formed by the open-faced channels of the second surface of the cathode electrode plate.

19. An anode electrode plate having opposing first and second surfaces, wherein the first surface has a recessed portion that has a plurality of open-faced channels and a fibrous composite material formed therein, wherein the second surface has a plurality of open-faced channels formed therein, wherein flow fields formed by the open-faced channels of the recessed portion of the first surface of the anode electrode plate are substantially perpendicular to flow fields formed by the open-faced channels of the second surface of the anode electrode plate.

20. A fuel cell comprising:
(a) an anode electrode plate;
(b) a cathode electrode plate; and
(c) an electrolyte located between the anode and cathode electrode plates,
wherein, each electrode plate has opposing first and second surfaces, the first surface of each plate being adjacent to the electrolyte, wherein at least one surface of each plate has a plurality of open-faced channels formed therein, with each channel having an inlet end and an outlet end.

21. The fuel cell of claim 20, wherein the second surface of the anode electrode plate and the second surface of the cathode electrode plate have a plurality of open-faced channels formed therein.

22. The fuel cell of claim 21, wherein flow fields formed by the open-faced channels of the second surface of the anode electrode plate are substantially parallel to flow fields formed by the open-faced channels of the second surface of the cathode electrode plate.

23. The fuel cell of claim 22, wherein the first surface of the anode electrode plate and the first surface of the cathode electrode plate are planar surfaces.

24. The fuel cell of claim 22, wherein the first surface of the anode electrode plate and the first surface of the cathode electrode plate have a plurality of open-faced channels formed therein.

25. The fuel cell of claim 24, wherein the flow fields formed by the open-faced channels of the first surface of the anode electrode plate are substantially perpendicular to the flow fields formed by the open-faced channels of the first surface of the cathode electrode plate.

26. The fuel cell of claim 22, wherein the first surface of the anode electrode plate and the first surface of the cathode electrode plate have recessed portions that have fibrous composite materials formed therein.

27. The fuel cell of claim 26, wherein the recessed portion of the first surface of the anode electrode plate and the recessed portion of the first surface of the cathode electrode plate have a plurality of open-faced channels formed therein.

28. The fuel cell of claim 27, wherein the flow fields formed by the open-faced channels of the recessed portion of the first surface of the anode electrode plate are substantially perpendicular to the flow fields formed by the open-faced channels of the recessed portion of the first surface of the cathode electrode plate.

29. A fuel cell comprising an anode electrode plate, a cathode electrode plate, and an electrolyte located between the anode and cathode electrode plates,
wherein, each electrode plate has opposing first and second surfaces, the first surface of each plate being adjacent to the electrolyte,
wherein the first surface of each plate has a recessed portion that has a plurality of open-faced channels and a fibrous composite material formed therein, wherein flow fields formed by the open-faced channels of the recessed portion of the first surface of the anode electrode plate are substantially perpendicular to flow fields formed by the open-faced channels of the recessed portion of the first surface of the cathode electrode plate,
wherein the second surface of each plate has a plurality of open-faced channels formed therein, wherein flow fields formed by the open-faced channels of the second surface of the anode electrode plate are substantially parallel to the flow fields formed by the open-faced channels of the second surface of the cathode electrode plate.

30. A fuel cell stack comprising, in cooperative combination, a plurality of the fuel cells comprising:
(a) an anode electrode plate;
(b) a cathode electrode plate; and
(c) an electrolyte located between the anode and cathode electrode plates,
wherein, each electrode plate in each fuel cell in the fuel cell stack has opposing first and second surfaces, the first surface of each plate being adjacent to an electrolyte, wherein at least one surface of each plate has a plurality of open-faced channels formed therein, with each channel having an inlet end and an outlet end.

31. The fuel cell stack of claim 30, wherein the second surface of the anode electrode plate and the second surface of the cathode electrode plate in each fuel cell in the fuel cell stack have a plurality of open-faced channels formed therein, wherein flow fields formed by the open-faced channels of the second surface of the anode electrode plate in each fuel cell in the fuel cell stack are substantially parallel to the flow fields formed by the open-faced channels of the second surface of the cathode electrode plate in an adjacent fuel cell in the fuel cell stack.

32. The fuel cell stack of claim 31, wherein the first surface of the anode electrode plate and the first surface of the cathode electrode plate in each fuel cell in the fuel cell stack have recessed portions that have a plurality of open-faced channels and a fibrous composite material formed therein, wherein flow fields formed by the open-faced channels of the recessed portion of the first surface of the anode electrode plate in each fuel cell in the fuel cell stack are substantially perpendicular to flow fields formed by the open-faced channels of the recessed portion of the first surface of the cathode electrode plate in each fuel cell in the fuel cell stack.

33. An acid fuel cell that comprises:
(a) an anode electrode plate;
(b) a cathode electrode plate; and
(c) an electrolyte located between the anode and cathode electrode plates,
wherein, the electrolyte is selected from the group of (i) an absorptive separator and an electrolyte comprising one or more acids, wherein the absorptive separator absorbs and retains the electrolyte, and (ii) a non-absorptive separator and a gelled electrolyte comprising one or more acid gels, wherein the non-absorptive separator retains the gelled electrolyte.

34. The acid fuel cell of claim 33, wherein the electrolyte comprises an absorptive separator and an electrolyte.

35. The acid fuel cell of claim 34, wherein the absorptive separator is a non-woven sheet formed from fibers selected from the group of fine glass fibers, inorganic fibers that have been rendered hydrophilic, and blends thereof.

36. The acid fuel cell of claim 33, wherein the electrolyte comprises a non-absorptive separator and a gelled electrolyte.

37. The acid fuel cell of claim 36, wherein the non-absorptive separator is selected from the group of glass fiber leaf type separators, polyvinyl chloride leaf type separators, cellulosic leaf type separators, synthetic pulp leaf type separators, and phenol formaldehyde resin separators.

38. A sulfuric acid fuel cell that comprises:
(a) an anode electrode plate;
(b) a cathode electrode plate; and
(c) an electrolyte located between the anode and cathode electrode plates,
wherein, the electrolyte comprises an absorptive separator and a liquid electrolyte comprising from about 10 to about 35% by wt. sulfuric acid, wherein, the absorptive separator is a non-woven sheet formed from fibers selected from the group of fine glass fibers, inorganic fibers that have been rendered hydrophilic, and blends thereof, and wherein, the absorptive separator absorbs and retains the liquid electrolyte.

39. A sulfuric acid fuel cell that comprises:
(a) an anode electrode plate;
(b) a cathode electrode plate; and
(c) an electrolyte located between the anode and cathode electrode plates,
wherein, the electrolyte comprises a non-absorptive separator and a gelled electrolyte comprising one or more acid gels, wherein the non-absorptive separator is selected from the group of glass fiber leaf type separators, polyvinyl chloride leaf type separators, cellulosic leaf type separators, synthetic pulp leaf type separators, and phenol formaldehyde resin separators, and wherein, the non-absorptive separator retains the gelled electrolyte.
